(19) United States
(12) Patent Application Publication
(10) Pub. No.: US 2020/0031016 A1
(43) Pub. Date: Jan. 30, 2020

(54) Maxflow Flow Inducement System

(71) Applicants: Nick Schott, West Chatman, MA (US); Desider Csongor, Manchester, MA (US)

(72) Inventors: Nick Schott, West Chatman, MA (US); Desider Csongor, Manchester, MA (US)

(21) Appl. No.: 15/998,276

(22) Filed: Jul. 27, 2018

(51) Int. Cl. B29B 7/40; B29B 7/42

(52) U.S. Cl. CPC B29B 7/408; B29B 7/429; B29B 7/421

(57) ABSTRACT

A mixer apparatus for the treatment of a polymer material to generate the Maxwell effect therein, at a rotor-stator interface in a mixer. The mixer comprises an alternating series of stators and rotors arranged along an elongated driveshaft supported within an elongated housing. The stators and rotors each having at least one helically arranged channel extending from an upstream end of the stator to an end location near the downstream end of that stator, those helically arranged channels preferably are arranged on the surface of the bore extending through the stator. A further generally radially directed channel from the end location of that helically arranged channel to a peripheral surface discharge at the downstream end of that stator is arranged to supply the polymer passing therethrough, to the upstream end of an adjacent rotor having a plurality of helically directed channels arranged on its outer periphery, those channels being inclined radially outwardly and of tapered dimension from an upstream end to a widened downstream end.

The present invention relates to processing systems for the treatment of polymers to induce the Maxwell effect during the flow and mixing of polymers occurring via several conveying principles and is based upon provisional application No. 62/605,550, filed Aug. 16, 2017 and is Incorporated herein by Reference in its entirety.

### BACKGROUND OF THE INVENTION

### Field of the Invention

A 1^{st} principle is the pressure flow in which a pressure gradient exists which forces the fluid or melt to flow in the direction of the lower pressure gradient. The flow rate is proportional to the pressure gradient for laminar Newtonian flow. For high molecular weight polymers, the flow rate varies with the power law exponent “n” of the shear rate where “n” is less than 1. The flow occurs for example, in mixing machines which would include a series of alternating rotors and stators arranged axially within a longitudinal housing. This flow through stators thus occurs by this principle if no moving walls are present.

A 2^{nd} principle for generating a flow of the polymer is called the Couette flow, which is a drag flow caused by a moving boundary. The movement of a solid surface drags the fluid next to the surface in the direction in which that surface is moving. This flow occurs in the rotors, particularly in fluted channels on the outer perimeter of those rotors.

The 3^{rd} principle for generating a flow of a polymer is called the Maxwell induced flow. This only occurs in high molecular weight polymers that exhibit a viscoelastic effect. This occurs due to the drag flow between the surfaces of a rotor and a stator. The tangential velocity causes a stretching and alignment of the molecules. The molecules can relax the induced stress by flowing radially inwardly where the tangential velocity decreases. Thus, this is the driving force for the Maxwell flow which causes a polymer melt to flow towards a driveshaft within a mixing apparatus. The combination of the pressure gradient and the Maxwell stress causes the melt to travel through the stator in the direction towards the die or discharge end of the mixer.

With the present invention, the Maxwell flow is only generated in high molecular weight polymeric fluids that can sustain a normal (tensile) stress. These molecules want to relax and that is why the melt travels in a radial inward direction in a gap between the rotor and the stator in the construction of the present invention. That high molecular weight melt has no driving force or incentive to go back outwardly in a radial direction for repeated exposure to a Maxwell flow field. In the present invention the high molecular weight melt flows radially inwardly in the gap which generates the high shear regions to which the melt is exposed. The high shear stress is required to break apart particulate fillers such as color concentrates and pigments which have a tendency to agglomerate and stick to each other. Each plastic resin and type of filler, concentrates, pigments etc. requires its own shear history. The design of the gap geometry, spacing, melt temperature and mixer rotational speed allow for the determination of optimum processing conditions. By doing master batches as in the prior art, they are costly and will be unsatisfactory in the end with a useless product if not properly dispersed. The field of carbon black compounding requires exact control of the structures of the black. Over shearing destroys that structure. The present invention can help create a whole spectrum of resins based on nanotechnology polymer alloying and blending.

It is an object of the present invention to thus overcome the disadvantages of the prior art.

It is a further object of the present invention to develop a system for efficiently generating and re-generating a Maxwell flow in a polymer.

It is yet a further object of the present invention to develop an adjustable system to produce such Maxwell flow depending upon the mixer components and the particularities of the polymer, and the filler/additive.

### BRIEF SUMMARY OF THE INVENTION

The present invention is for the development of the Maxwell effect on polymer production through an elongated mixer apparatus (such as for example, a DMX™ mixer of DMX, Inc.), which mixer typically comprises an alternating series of rotors and stators configured about a longitudinally extending rotatable driveshaft, arranged within an elongated barrel shaped housing. In this mixer apparatus, a polymer is introduced in the upstream end thereof typically via a feed screw arrangement.

The flow path of the polymer and the shape characteristics of that flow path are critical to the development of the Maxwell effect (elongation of polymer molecules) with respect to that polymer. Such flow path originates at the upstream side of the first or upstream most stator. It is to be noted that the elongated driveshaft extends longitudinally and rotatively through a central bore longitudinally arranged through each respective stator.

Each rotor preferably includes a hub extending from a downstream side thereof. Each rotor and its connected hub have a central bore extending longitudinally therethrough. The hub of the rotor is arranged to mate within the bore of its downstream adjacent stator, and in a spacer-induced spaced-apart manner. That downstream adjacent stator has a downstream adjacent rotor thereadjacent. Each rotor has a keyway. Each rotor is arranged on the downstream side of the each stator and is securely attached via its keyway to mate with a key onto the central, longitudinally extending driveshaft and hence rotates accordingly therewith.

Each stator has one or more longitudinally and angularly extending channels extending along the wall of its bore from a 1^{st} size channel 1^{st} opening at the upstream end of the stator bore to a 2^{nd} size channel 2^{nd} opening at the downstream end of the stator bore, the channel being bordered on its innermost side by the rotatable driveshaft which generates drag flow in each stator channel. Each channel or conduit within the wall of the bore of the stator preferably widens and is inclined radially outwardly towards the downstream or discharge end of the stator. This assures that the total melt flow in the stator is redirected radially outwardly closer to the housing of the mixer apparatus, so as to deliver the melt into the next rotor stator gap where the Maxwell effect processing will again take place.

Each rotor has one or more generally longitudinally extending yet preferably helically disposed channels or conduits extending along the outer periphery of that rotor. Each channel or conduit helically disposed on the outer periphery of the rotor preferably widens and in one preferred embodiment, deepens from its upstream end to its downstream end from a 1^{st} size channel 1^{st} opening at the upstream end of the rotor or periphery to a 2^{nd} size channel 2^{nd} discharge opening at the downstream end on the rotor periphery.

Rotation of the respective the rotors relative to the respective adjacent stators represents alternating opening and closing of the polymer flow path while inducing a Maxwell flow. The Maxwell flow is regenerated by having the center of mass of each stator discharge opening at a greater radial distance from the axis of rotation of the driveshaft. Thus each stator channel delivers the melt to the outer perimeter of the rotor-stator gap to again regenerate the Maxwell flow.

The radial redirection of the rotor channels and the cross-sectional shape of its area delivers melt into the stator-rotor gap with the mass flow of melt being at or near its maximum outward radial position so that the Maxwell effect in the gap is maximized. The Maxwell effect will force a portion of the melt flow to travel radially inwardly toward the driveshaft, to be exposed to the very high shear rates therewithin. Close to the shaft, a series of stator channels captures the melt and the combined Maxwell effect and a pressure gradient induce the melt to flow into the stator channels. The stator channels preferably also have a helical angle and the rotating inner stator attached to the preceding rotor causes the drag flow in each stator channel to convey melt downstream towards the die discharge end of the mixer apparatus.

The regenerative Maxwell flow is accomplished by having each stator channel inclined at an angle radially outward while at the same time of the cross sectional area of the flow of each channel is changed to get the maximum width in the circumferential direction while decreasing its radial thickness of the flow. The melt flow downstream in each stator channel is redirected radially outwardly while the cross-sectional area of each channel is increased to optimize the melt flow to its maximum to the outermost perimeter of the next rotor-stator interfaces with the Maxwell effect will reoccur again and again.

The mixer apparatus performance is experimentally optimized by adjusting the gap between adjacent rotors and stators, setting the melt temperature, controlling and adjusting the screw rpm of the shaft and being aware that the melt viscosity will change with the shear rate, which is a function of distance, radial position, and tangential velocity. The melt viscosity will also change with the melt temperature. Viscosity decreases non-linearly as the absolute temperature goes up. The relaxation time of the molecules also decreases exponentially with increasing melt temperature. Much of the mechanical energy put into the mixer apparatus is dissipated as heat, viscous dissipation for example (frictional heat), raises the melt temperature and changes the viscosity as mentioned hereinabove. Each polymer needs different processing conditions and even the same polymer requires specific conditions based on its molecular weight and molecular weight distribution.

Thus, in one preferred embodiment, the channel at the stator downstream or discharge end should be wider and located further radially outwardly than is the channel at the stator upstream or flow receiving end, thereby transmitting the polymer melt further radially outwardly and into the gap between its downstream adjacent rotor. Such radial differential in the flow of the mix promotes good development of Maxwell flow by maximizing tangential velocity between longitudinally adjacent (spaced slightly axially apart) stators and rotors. The axial spacing between adjacent stators and rotors may be adjusted by the addition or removal of “O” ring members there between.

A further preferred embodiment of the channels for each of the stators and rotors is that their cross-sectional area are generally equal to one another. A further preferred embodiment of the channels for each of the stator and rotors is that their cross-section may be of “U” shape, or of rectilinear shape in cross-section. The cross sectional area of axially adjacent channels in the stators and rotors are not to be in complete longitudinal alignment with one another so as to provide a radial displacement to the flow of polymer between adjacent rotors and stators. A 20% to 40% overlap between axially adjacent channels in adjacent rotors and stators is preferred. Such incomplete radial alignment thus facilitates the Maxwell effect as the polymer transits the gap between axially adjacent stators and rotors, and rotors and stators. This means that the area for flow is not completely blocked as a stator channel passes in front of a rotor channel, but the repetitive partial occlusion also induces an extensional flow as the flow area decreases then increases in a repetitive manner. A higher shear rate occurs as the flow area decreases then in 2 phase blends/alloys, the interfacial area of the discontinuous phase increases which is highly desired.

The rotation of the respective rotors relative to their respective axially adjacent (but not full radial alignment) stators presents alternating opening and closing (periodic occlusion) of the polymer flow path while inducing radial flow both radially outwardly and radially inwardly during the polymer transit through the elongated mixer apparatus, in what might be described as a “saw tooth” path transiting between adjacent rotors and stators while also flowing in a helical path.

In one preferred embodiment of the mixer apparatus of the present invention, one or more O-rings or spacers may be inserted between adjacent rotors and stators to adjust the gap therebetween and hence accommodate the particularities of a variety of polymers being driven through the mixer apparatus.

In yet a further preferred embodiment of the mixer apparatus of the present invention, the number of channels arranged on the peripheral surface of the rotor is different from the number of channels arranged on the internal surface of the bore of the stator.

To further carry out the Maxwell effect on a polymer so as to enable the forced elongation of the polymer molecules, a pinched waist effect induces increased velocity to the polymers driven through the various conduits.

The cycle of the Maxwell effect inducing polymer molecule elongation may thus continue through to the output or die end of the mixer apparatus through an alternating series of (adjustable, by for example the adding or removing of one or more “O” rings arranged therebetween) axially adjacent rotors and stators on the driveshaft, each with their respective channels of downstream increasing width and downstream increasing depth to effect that polymer transformation.

The Maxwell effect is generated in the gap between the respective adjacent rotors and stators. It is generated due to the visco-elastic behavior of polymer melts and solutions. The shear field can be controlled by adjustably changing the gap size, the tangential velocity of the rotor, and the diameter of the rotor and the stator. A high shear field is desirable for the exfoliation of nano-particles such as nano-clays. The melt temperature also has a significant effect since the viscosity decreases exponentially with the increase in absolute temperature. The viscosity also decreases with increasing shear rate, again exponentially for the polymer melts which are power law fluids.

The invention includes a drag flow generated inside of the stator by means of the channel in the wall of the bore therethrough. The relative motion of the rotating shaft induces a drag flow inside of the channel between the channel and the rotatable shaft to convey the melt downstream towards the mixer discharge end.

### The Regenerative Maxwell Flow Summarized

The polymer melt that is experiences the Maxwell effect between a rotor and a stator is conveyed toward the discharge end by the channels arranged through the inside of the stator. Drag flow was created by the relative rotation of the drive shaft rotating within the central bore of the stator with its internal channels distributed therearound. This creates a pressure gradient. This melt is then partially discharged into the adjacent downstream rotor channels while the remainder of the melt is forced into the rotor-stator gap and its different radial location relative to the component the melt just passed through, to again cause the elongation of the polymers, that is, the Maxwell flow effect. This process and structure of the present invention defines an arrangement to repeatedly generate Maxwell flow. The Maxwell flow also depends upon the type of polymer, the melt temperature which affects melt viscosity, the melt shear rate and also the stream relaxation time of the molecules. Higher temperatures give shorter relaxation times. The shear rate is controlled by the shaft rpm as well as the gap between the rotor and the stator. The radial position of the melt in the gap also determines its shear rate. The shear rate increases with radial distance from the axis of rotation of the driveshaft. The shear rate will affect the shear heating of the melt and also the melt viscosity according to the power law equation. Higher shear rates will exponentially decrease the melt viscosity. The melt viscosity will also decrease exponentially with increasing absolute temperature. Geometry and process settings of the mixer allow one to optimize this process.

The invention thus comprises a Maxwell effect generating elongated mixer apparatus for the treatment of a polymer material, comprising: an elongated housing having an upstream feed end for receipt of a polymer material to be treated, and a downstream discharge end, for extruded discharge of a treated polymer material; an elongated rotatably driven driveshaft extending through the elongated housing, the driveshaft having a longitudinal extending axis of rotation; an elongated alternating array of stators and rotors arranged on the driveshaft for treating a polymer material within the elongated housing, wherein at least one stator has a bore surface therewithin, the bore surface having at least one polymer flow treatment channel extending axially therein, and wherein at least one rotor has an outer peripheral surface with at least one polymer flow treatment channel extending axially therein; and wherein the at least one polymer flow treatment channel in the rotors and the at least one polymer flow treatment channel in the stators are in a radial misalignment with one another with respect to the axis of rotation of the driveshaft. A spacer is preferably disposed about the driveshaft, between the at least one stator and its adjacent rotor, to define an adjustable gap therebetween. The at least one stator having polymer flow treatment channel therewithin has an upstream side and a downstream side, and the at least one polymer flow treatment channel extending therethrough has an upstream end and a downstream end, wherein in the downstream end of the polymer flow treatment channel is wider in the stator than the upstream end of the channel in an upstream end thereof. The at least one stator has a plurality of polymer flow treatment channels therewithin and wherein the at least one rotor has a plurality of polymer flow treatment channels thereacross, the polymer flow treatment channels within the at least one stator being of a different number than the polymer flow treatment channels arrayed across the at least one rotor. The at least polymer treatment channel in the at least one rotor is helically disposed on the at least one rotor. The at least one polymer treatment channel in the at least one stator has an upstream end and a downstream end of different cross-sectional configuration. The at least one polymer treatment channel in the at least one stator has an inclination with respect to the longitudinal axis of rotation of the driveshaft. The inclination of the at least one polymer treatment channel increases radially outwardly at the downstream end of the stator.

The invention also comprises a process of elongating the molecular length of a long chain polymer by the steps of: Introducing a polymer into an upstream end of an elongated polymer treating mixing apparatus; driving the polymer into a first channel of a first rotatable rotor in the upstream end of the mixer apparatus, and pushing out that polymer out a downstream end of the first channel, wherein the upstream end of the first channel is shallower than the downstream end of the first channel; and driving the polymer into a first channel of a first stator downstream of and adjacent to the first rotor in the mixer apparatus, and pushing out that polymer out a downstream end of the first channel in the first stator, wherein the upstream end of the first channel in the first stator has a greater radial depth therein and the downstream depth of the first channel in the first stator has a circumferentially wider and shallower radial depth than at its upstream end. The process includes arranging a spacer between the rotatable rotor and the stator downstream and adjacent to the rotatable rotor to create a gap therebetween within the elongated polymer treating mixer apparatus so as to enable accommodation of various polymers treated thereby.

The invention also comprises a mixer apparatus for the treatment of a polymer material to generate the Maxwell effect therein, comprising an alternating series of stators and rotors arranged along an elongated driveshaft supported within an elongated housing, the stators and rotors each having a particular channel configuration therein, that channel configuration comprising: at least one longitudinally arranged channel extending from an upstream end of the stator to the downstream end of that stator, and at least one longitudinally arranged channel extending from an upstream end of an adjacent rotor to a downstream end of the adjacent rotor, each of these at least one channels having a helical curve thereto and those channels being of tapered dimension from an upstream end to a widened downstream end. The invention includes an adjustable gap between the adjacent stators and rotors. The invention includes generally straight elongated channels extending through the stator from an upstream end to a downstream end therein, tapering to a wider dimension at its downstream end. The invention includes the at least one channel and the stator is inclined radially outwardly from its upstream end to its downstream end.

The helix or helical angle and the rotor in state or channels is significant. The value of the side of the angle determines the amount of forward drag to with the die discharge end of the apparatus. If an angle of 0° is used, the drag velocity in the circumferential direction is maximum, but it contributes 0 to the mixer output. In a single screw extruder, a compromise angle of about 18° gives a good mixing with the drag flow and also good output rate velocity component in the discharge direction. Further, the present invention permits a periodic at least partial occlusion of the area of flow in each stator channel as the wall of a rotor channel passes in front of it. This partial occlusion is permitted by the area of the rotor channel wall being different from the interior of the stator channel wall or by staggering the distance between the rotor and stator channels so that they don't get blocked simultaneously. Such an occlusion is repetitive.

### BRIEF DESCRIPTION OF THE DRAWINGS

The objects and advantages of the present invention will become more apparent when viewed in conjunction with the following drawings, in which:

FIG. 1 is a side elevational view, in longitudinal section, of a mixing apparatus constructed according to the principles of the present invention;

FIG. 2 is a perspective view of the elongated mixer showing the alternating rotors and stators mounted upon a shaft on which shaft, the alternating rotor and stator arrangement is shown within the mixer apparatus housing of FIG. 1;

FIG. 3 is a perspective view of a rotor showing the external peripheral array of angled, tapered channels;

FIGS. 4A and 4B are an end view of the upstream end and a sectional view of a stator along B-B, showing the tapering, helical aspect of its internal channels;

FIG. 5 is a longitudinal sectional view, shown here in perspective, presenting the tapered internal channels of the stator shown in FIG. 4;

FIG. 6 is a perspective view of a full stator, shown only partially in FIG. 5; and

FIG. 7 is a side elevational view of a further embodiment of the rotor and stator combination represented in FIGS. 1 and 2.

### DESCRIPTION OF THE INVENTION IN DETAIL

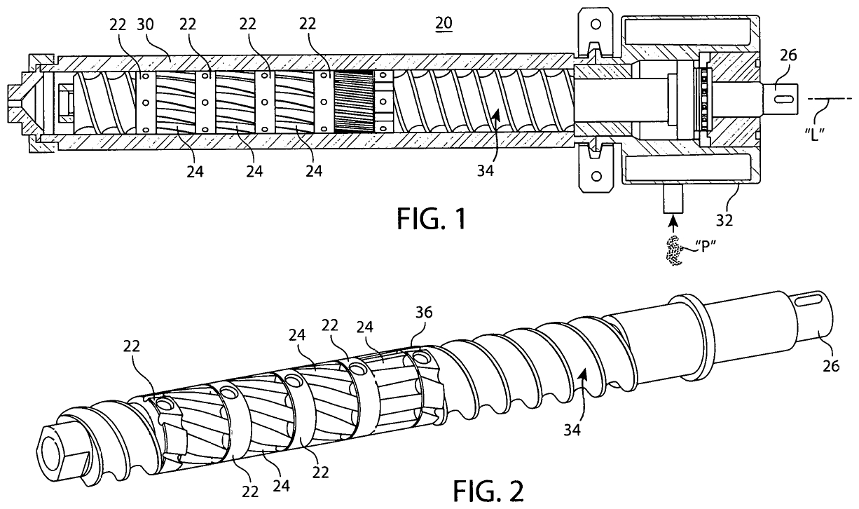

Referring now to the drawings in detail, and particularly to FIG. 1, there is shown the present invention for the development of the Maxwell effect on polymer production through an elongated mixer apparatus 20 (such as for example, the trademarked DMX™ mixer of DMX, Inc.), which mixer apparatus 20 typically comprises an alternating series of stators 22 and rotors 24 configured about a longitudinally extending rotatable driveshaft 26, having and rotatable about a longitudinal axis of rotation “L”, arranged within an elongated barrel shaped housing 30. In this mixer apparatus 20, a polymer “P” is introduced in the upstream end 32 thereof typically via a feed screw arrangement 34.

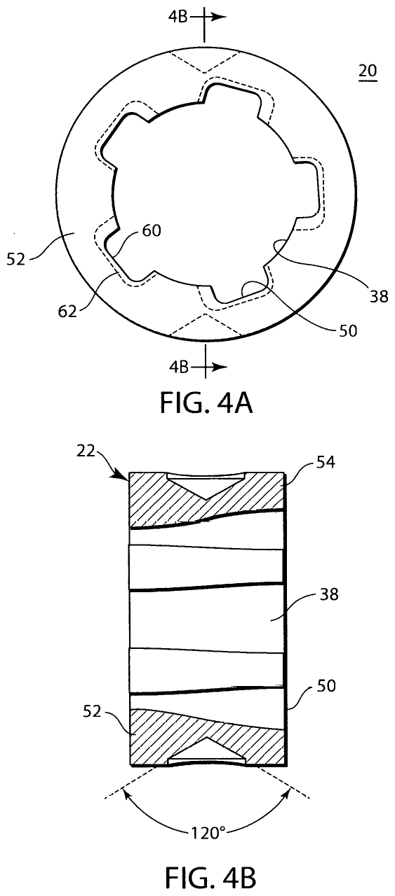

The flow path of the polymer and the shape characteristics of that flow path are critical to the development of the Maxwell effect (elongation of polymer molecules) with respect to that polymer “P”. Such flow path originates at the upstream side of the first or upstreammost stator 36, as best represented in isometric view in FIG. 2. It is to be noted that the elongated driveshaft 26 extends longitudinally and rotatively through a central bore 38 longitudinally arranged through each respective stator 22/36, the bore 38 represented in FIGS. 4, 5 and 6.

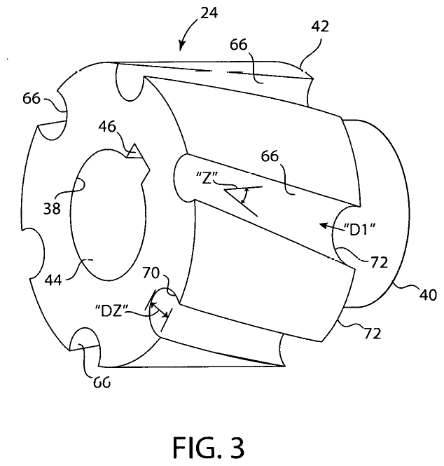

Each rotor 24, shown in FIGS. 1 and 2, but represented most clearly in FIG. 3, preferably includes a hub 40 extending from a downstream side 42 thereof. Each rotor 24 and its connected hub 40 have a central bore 44 extending longitudinally therethrough. The hub 40 of the rotor 24 is arranged to mate within the bore 38 of its downstream adjacent stator 22. That downstream adjacent stator 22 has a further downstream adjacent rotor 24 thereadjacent, as is represented in FIGS. 1 and 2. Each rotor 24 has a keyway 46, as shown in FIG. 3. Each rotor 24 is arranged on the downstream side of the each stator 22 and is securely attached via its keyway 46 to mate with a key (not shown for clarity of figures) onto the central, longitudinally extending driveshaft 26 and hence rotates accordingly therewith.

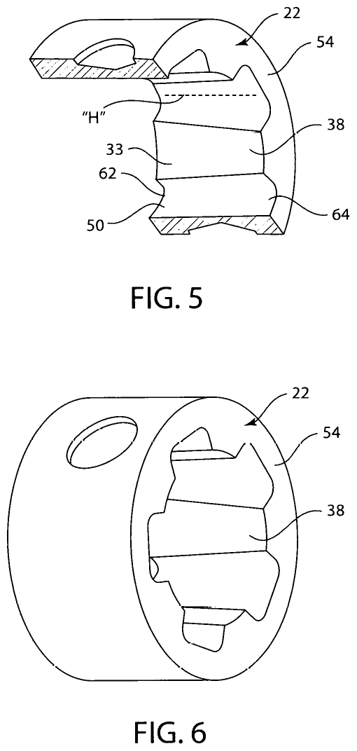

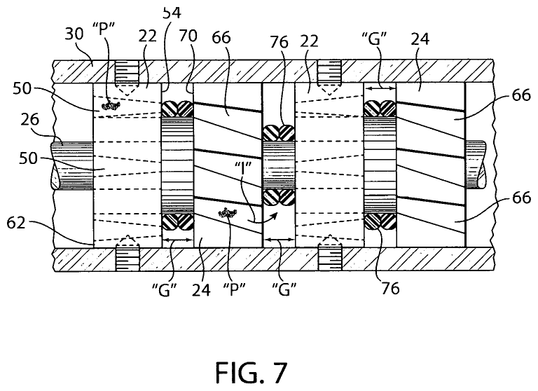

Each stator 22 has one or more internal, longitudinally extending, helically arranged channels 50 extending along the wall of its bore 38 from a 1^{st} size/shape channel 1^{st} opening 60 at the upstream end 52 of the stator 22 to a 2^{nd} size/shape channel 2^{nd} opening 62 at the downstream end 54 of the stator 22, best shown in FIG. 4A, the sectional view B-B of FIG. 4A, as shown as FIG. 4B, and FIGS. 5 and 6, the channels 50 being bordered on its innermost side by the rotatable driveshaft 26, as represented in FIG. 7. Each channel 50 within the wall 33 of the bore 36 widens and preferably inclines radially outwardly, downstream, than its entry opening upstream in that channel, (hence discharging flow more radially outwardly closer to the housing) at the downstream end 54 of the stator 22 with respect to the axis “L”, and also as is evident form the dashed lines in FIG. 4A, and as represented in a sectional view B-B in FIG. 4B, and as may be seen more clearly in the sectional view of FIG. 5. Such channel(s) 50 are also preferably of helical orientation (at preferably between about 15 to about 30 degrees) between its upstream end and its downstream end, as may be envisioned by line “H” of slight helical direction, shown in FIG. 5. This assures that the total melt flow in the stator 22 is redirected downstream, and also inclined radially outwardly downstream as far as possible within the housing 30 to deliver the polymer melt “P” into the rotor stator gap “G”, as represented in FIG. 7, where the Maxwell effect (molecular elongation) will again take place.

Each rotor 24 has one or more generally longitudinally extending yet helically disposed channels or conduits 66 (at about 15 to about 30 degrees) extending along the outer periphery 68 of that rotor 24, as may be seen by angle “Z” in FIG. 3. Each channel 66 helically disposed on the periphery of the rotor 24 widens, and in one embodiment, deepens from its upstream end 70 to its downstream end 72 from a shallow, narrow 1^{st} size and/or shape channel 1^{st} opening at the upstream end 70 of the rotor's periphery 68 to a 2^{nd} size and/or shape channel 2^{nd} discharge which is a deeper and widened opening at the downstream end 72 on the rotor periphery 68, as may be seen in FIG. 3.

The depth “D1” of the channel 66 cut into the periphery 68 of the downstream end 72 of the rotor 24 is preferably radially greater than the depth “DZ” of the channel 66 cut into the upstream end 62 of the bore 33 of the stator 22, as evident from FIGS. 4, 5 and 7, thus effecting radially inward flow of polymer “P”, as shown by arrow “I” in FIG. 7, as that polymer traverses a gap “G” going between a rotor 24 to an adjacent downstream stator 22. Rotation of the respective rotors 24 relative to the respective adjacent stators 22 represents alternating opening and closing of the polymer flow path while inducing a Maxwell flow, because of the varying shape and non-alignment between their respective longitudinally adjacent channels 66 and 50. The Maxwell flow of a polymer is regenerated by having the center of mass of each stator discharge channel at a greater radial distance from the axis of rotation “L”. Thus each stator channel 50 delivers the melt to the outermost perimeter of the rotor-stator gap “G” to regenerate the Maxwell flow driving it radially inwardly for successive flow into its next downstream rotor channel which is inclined radially slightly outwardly.

Thus, in one preferred embodiment, the channel 50 at the stator discharge end 54 should be wider and deeper (bottom of channel being radially further from the axis of rotation of the driveshaft 26) than the channel 50 is at the stator flow-receiving (upstream) end 62, thereby transmitting the polymer melt further radially outwardly and then radially inwardly into the gap “G” next to its downstream adjacent rotor 24. Such radial differential in the flow of the mix promotes good development of Maxwell flow by maximizing tangential velocity (because it is travelling further radially outwardly) between longitudinally adjacent (spaced slightly axially apart) stators and rotors. The axial spacing or gap “G” between adjacent stators 22 and rotors 24 may be adjusted by the addition or removal of “O” ring members 76 therebetween, as represented in FIG. 7.

A further preferred embodiment of the channels 50/66 for each of the stators 22 and rotors 24 is that their cross-sectional areas are preferably generally equal to one another, differing in shape in another embodiment, as for example, of rectilinear shape at their downstream ends. A further preferred embodiment of the channels 50/66 for each of the stator 22 and rotor 24 is that there cross-section may be of “U” shape, or of rectilinear shape in cross-section. The cross-sectional area of axially adjacent channels in the stators 22 and rotors 24 are preferably not to be in complete longitudinal alignment with one another so as to provide the radial displacement to the downstream flow of polymer “P” between adjacent rotors 24 and stators 22. A 20% to 40% limited overlap between axially adjacent channels 66 and 50 in adjacent rotors 24 and stators 22 is preferred. Such incomplete alignment thus facilitates the Maxwell effect as the polymer transits the gap “G” between axially adjacent stators 22 and rotors 24, and rotors 24 and stators 22. The repetitive channel occlusion also induces extensional flow which is very important for the two or multiphase systems.

The rotation of the respective rotors relative to their respective axially adjacent (but not full radial alignment) stators presents alternating opening and closing (periodic occlusion) of the polymer flow path while inducing radial flow both radially outwardly and radially inwardly during the polymer transit through the elongated mixer apparatus, in what might be described as a “saw tooth” path.

In yet a further preferred embodiment of the mixer apparatus of the present invention, the number of channels 66 arranged on the peripheral surface of the rotor 24 is different from the number of channels 50 arranged on the internal surface of the bore 38 of the stator 22.

To further carry out the Maxwell effect on a polymer so as to enable the forced elongation of the polymer molecules, a pinched waist effect induces increased velocity to the polymers driven through the various conduits. However, this is more costly to machine and may not be worth it. The main elongational flow occurs by repetitive occlusion of the channels as the metal of a rotor channel wall partially blocks the entrance into a downstream stator channel in a variable cyclical and periodic manner.

The cycle of Maxwell effect inducing polymer molecule elongation may thus continue through to the downstream output or die end of the mixer apparatus through an alternating series of (adjustable, by for example the adding or removing one or more “O” rings 76 arranged therebetween) axially adjacent rotors 24 and stators 22 on the driveshaft 26, each with their respective stator channels of downstream increasing width and rotor downstream channels increasing depth to effect that polymer transformation.

The Maxwell effect is hence repetitively generated in the gap “G” between the respective adjacent rotors 24 and stators 22. It is generated due to the visco-elastic behavior of polymer melts and solutions. The shear field can be controlled by adjustably changing the gap size, the tangential velocity of the rotor 24, and the diameter of the rotor 24 and the stator 22. A high shear field is desirable for the exfoliation of nano-particles such as nano-clays. The melt temperature also has a significant effect since the viscosity decreases exponentially with the increase in absolute temperature. The viscosity also decreases with increasing shear rate, again exponentially for the polymer melts which are power law fluids. It should be noted that the polymer melts undergo viscous frictional shear heating. For small-scale equipment this leads to an isothermal melt temperature in the mixer when the internally generated heat is lost to the surroundings of the mixer under steady-state conditions. For large-scale mixers there is not enough mixer surface area and the mixer goes into an adabiatic mode and the melt temperature increases. The melt temperature can be controlled however by reducing the mixer speed. Scale-up development work is required for each application.

We claim:

1. A Maxwell effect generating elongational mixer apparatus for the treatment of a polymer material, comprising:
an elongated housing having an upstream feed end for receipt of a polymer material to be treated, and a downstream discharge end, for extruded discharge of a treated polymer material;
an elongated rotatably driven driveshaft extending through the elongated housing, the driveshaft having a longitudinal extending axis of rotation;
an elongated alternating array of stators and rotors arranged on the driveshaft for treating a polymer material within the elongated housing, wherein at least one stator has a bore formed treatment surface arrangement therewithin, the bore formed treatment surface arrangement comprising a polymer flow treatment channel extending from an upstream end thereof to a downstream end thereof, and wherein at least one rotor has an outer peripheral surface thereon, with a polymer flow treatment channel arrangement extending from an upstream end thereof to a downstream end thereof; and
wherein each polymer flow treatment channel arrangement in the at least one rotor and the at least one stator extend in a helical configuration from their respective upstream ends to their respective downstream ends, and each polymer flow treatment channel arrangement in the at least one rotor and in the at least one stator are in a radial misalignment with one another with respect to the axis of rotation of the driveshaft.

2. The Maxwell effect generating elongated mixer apparatus as recited in claim 1, wherein a spacer is disposed about the driveshaft, between the at least one stator and its adjacent rotor, to define an adjustable gap therebetween.

3. The Maxwell effect generating elongated mixer apparatus as recited in claim 1, the at least one stator having polymer flow treatment channel therewithin has an upstream side and a downstream side, and the at least one polymer flow treatment channel extending therethrough has an upstream end and a downstream end, wherein in the downstream end of the polymer flow treatment channel is wider in the stator than the upstream end of the channel thereof.

4. The Maxwell effect generating elongated mixer apparatus as recited in claim 1, wherein the at least one stator has a plurality of polymer flow treatment channels therewithin and wherein the at least one rotor has a plurality of polymer flow treatment channels thereacross, the polymer flow treatment channels within the at least one stator being of a different number than the polymer flow treatment channels arrayed across the at least one rotor.

5. The Maxwell effect generating elongated mixer apparatus as recited in claim 1 wherein the at least polymer treatment channel in the at least one rotor is wider at the downstream end thereof than at its upstream end.

6. The Maxwell effect generating elongated mixer apparatus as recited in claim 1 wherein the at least one polymer treatment channel in the at least one stator has an upstream end and a downstream end of different cross-sectional configuration.

7. The Maxwell effect generating elongated mixer apparatus as recited in claim 6 wherein the at least one polymer treatment channel in the at least one stator has a downstream-directed increasing inclination with respect to the longitudinal axis of rotation of the driveshaft.

8. The Maxwell effect generating elongated mixer apparatus as recited in claim 7, wherein the inclination of the at least one polymer treatment channel increases radially outwardly at the downstream end of the stator.

9. A process of elongating the molecular length of a long chain polymer melt or solution through an elongated polymer treating mixer apparatus having an alternating series of rotors and stators mounted on a driveshaft, each of the rotors having an external periphery with an array of channels thereon, each of the stators having an internal bore therein, with an array of channels cut therein, the process comprising steps of:
Introducing a polymer into an upstream end of an elongated polymer treating mixer apparatus;
driving the polymer into a first channel of a first rotatable rotor in the upstream end of the mixer apparatus, and pushing out that polymer at a downstream end of the first channel, wherein the upstream end of the first channel is shallower than the downstream end of the first channel; and
driving the polymer into a first channel of a first stator downstream of and adjacent to the first rotor in the mixer apparatus, and pushing out that polymer out a downstream end of the first channel in the first stator, wherein the upstream end of the first channel in the first stator has a greater radial depth therein and the downstream depth of the first channel in the first stator has a circumferentially wider and shallower radial depth than at its upstream end, to effect radial displacement of the polymer being treated between adjacent stators and rotors as the adjacent stators and rotors are angularly displaced from one another by rotation of the driveshaft rotating the rotors thereattached.

10. The process as recited in claim 9, including:
arranging a spacer between the rotatable rotor and the stator downstream and adjacent to the rotatable rotor to create a gap therebetween within the elongated polymer treating mixer apparatus so as to enable accommodation of various polymers treated thereby.

11. The process as recited in claim 9, wherein the array of channels in the rotors are of helical orientation.

12. The process as recited in claim 9, wherein the array of channels in the stators are of helical orientation.

13. The process as recited in claim 9, wherein the channels in the rotors and the channels in the stators are of different numbers from one another.

14. The process as recited in claim 13, wherein the channels in adjacent rotors and stators are occluded from one another during a portion of their respective angular displacement within the mixer apparatus.

15. The process as recited in claim 13, wherein the channels in the rotors and the channels in the stators are sloped with respect to the longitudinal axis of rotation of the driveshaft.

16. An elongated mixer apparatus having an upstream end and a downstream end, the mixer apparatus arranged to enable the treatment of a polymer material to generate a Maxwell molecular-elongation-effect therein, the mixer apparatus comprising an alternating series of stators and rotors arranged along an elongated rotatable driveshaft, the driveshaft having a longitudinal axis of rotation, the driveshaft being rotatable about that longitudinal axis of rotation, and supported within an elongated housing, the stators and rotors each having a particular channel configuration therein, that channel configuration comprising:
at least one longitudinally arranged channel extending from an upstream end of the stator to the downstream end of that stator, and at least one longitudinally arranged channel extending from an upstream end of an adjacent rotor to a downstream end of the adjacent rotor, each of these at least one channels having a helical curve thereto and each of these channels being of tapered dimension from an upstream end to a widened downstream end.

17. The mixer apparatus as recited in claim 16, including an adjustable gap between the adjacent stators and rotors.

18. The mixer apparatus as recited in claim 16, including generally straight elongated channels extending through the stator from an upstream end to a downstream end therein, tapering to a wider dimension at its downstream end.

19. The mixer apparatus as recited in claim 16 wherein the at least one channel in the stator and at least one channel in the rotor is inclined radially outwardly from its upstream end to its downstream end.

20. The mixer apparatus as recited in claim 19, wherein the polymer material being treated within the elongated housing by a spaced-apart series of alternating stators and rotors simultaneously follows a saw tooth path and a helical flow path as it is treated from the upstream end to the downstream end of the within the housing.
